(19) United States
(12) Patent Application Publication
(10) Pub. No.: US 2012/0082974 A1
(43) Pub. Date: Apr. 5, 2012

(54) ELECTRONIC TEACHING SYSTEM

(75) Inventors: Alexander Shustorovich, New York, NY (US); Olga Zakharova, Moscow (RU); Natalia Churakova, Moscow (RU)

(73) Assignee: PLEIADES PUBLISHING LIMITED INC., New York, NY (US)

(21) Appl. No.: 13/010,997

(22) Filed: Jan. 21, 2011

Related U.S. Application Data
(60) Provisional application No. 61/390,145, filed on Oct. 5, 2010.

(30) Foreign Application Priority Data
Dec. 28, 2010 (RU) 2010153754
Dec. 28, 2010 (RU) 2010153757

(51) Int. Cl. G09B 19/00

(52) U.S. Cl. 434/429

(57) ABSTRACT

Systems, methods, and apparatus that couple portable educational terminal(s) with an instructor interface by way of an interactive, real-time educational system are presented herein. An educational component can be configured to authorize, via a network computing environment, a first communication between the educational component and an educational terminal; authorize, via the network computing environment, a second communication between the educational component and an instructor interface; and transfer, via the network computing environment, educational path information between the educational terminal and the educational component in response to the second communication. The educational path information can include digitized textbook information and/or relate to a lesson plan associated with the educational terminal. Further, the educational component can be configured to authorize the first communication in response to at least one of an alphanumeric registration, a voice activated registration, a biometric registration, or first information associated with the educational terminal.

### PRIORITY CLAIM

This application claims priority to U.S. Provisional Patent Application Ser. No. 61/390,145, filed on Oct. 5, 2010, entitled “ELECTRONIC TEACHING SYSTEM.” Further, this application claims priority to Russian Patent Application Number 2010153754, filed on Dec. 28, 2010, and claims priority to Russian Patent Application Number 2010153757, filed on Dec. 28, 2010. The entirety of the aforementioned applications is incorporated by reference herein.

### TECHNICAL FIELD

This disclosure relates generally to electronic teaching technologies.

### BACKGROUND

Conventional educational technologies utilize computer-aided systems; however, such technologies lack digital teaching aids oriented towards efficient instruction.

The above-described deficiencies of today's educational and related technologies are merely intended to provide an overview of some of the problems of conventional technology, and are not intended to be exhaustive. Other problems with the state of the art, and corresponding benefits of some of the various non-limiting embodiments described herein, may become further apparent upon review of the following detailed description.

### SUMMARY

The following presents a simplified summary to provide a basic understanding of some aspects described herein. This summary is not an extensive overview of the disclosed subject matter. It is not intended to identify key or critical elements of the disclosed subject matter, or delineate the scope of the subject innovations. Its sole purpose is to present some concepts of the disclosed subject matter in a simplified form as a prelude to the more detailed description presented later.

Conventionally, educational technologies lack digital teaching aids oriented towards efficient instruction. To correct for these and other drawbacks of conventional educational technologies, various systems, methods, and apparatus described herein couple portable educational terminal(s) with an instructor interface by way of an interactive, real-time educational system. For example, the educational system can include an educational component that can authorize, via a network computing environment, communication(s) between the educational component and an educational terminal. The educational system can further authorize, via the network computing environment, communication(s) between the educational component and an instructor interface. Further, the educational system can transfer, via the network computing environment, educational path information between the educational terminal and the educational component in response to the communication(s) between the educational component and the instructor interface. In one example, the educational path information can include digitized textbook information and/or information related to a lesson plan, e.g., presented on multiple displays of the educational terminal.

In another example, the educational component can be configured to authorize communication(s) between the educational component and the educational terminal in response to an alphanumeric registration, a voice activated registration, a biometric registration, and/or information related to the educational terminal, e.g., a device identification, an internet protocol (IP) address, etc.

In yet another example, the educational component can be configured to authorize communication(s) between the educational component and the instructor interface in response to information, e.g., pass code(s), lesson plan information, etc. stored in a database, e.g., server(s), etc. of the educational component.

In one example, the educational component can be configured to authorize communication(s) between the educational terminal and the instructor interface. In another example, the educational component can be configured to authorize communication(s) between a parental interface and (1) the educational component; (2) the instructor interface; and/or (3) the educational terminal. In yet another example, the educational component can be configured to authorize communication(s), e.g., via a wiki forum, between the educational terminal and another educational terminal. In one example, the educational component can be configured to authorize communication(s) between an administrator component and (1) the educational component; (2) the instructor interface; (3) and/or the educational terminal.

In another example, the instructor interface can be configured to track, via the network computing environment, tracking information, e.g., a location of the educational terminal, information related to a lesson plan, etc. related to the educational path information. In yet another example, the instructor interface can be configured to select the educational path information, e.g., an instructional based incentive, an additional task related to the educational path information, a lesson plan, a test, etc. in response to the tracking information.

In one example, a portable communications device can include means for receiving information, e.g., test/homework/class work responses and/or questions related to a lesson plan, etc. via at least one of a sound-based interface of the portable communications device or a touch-based interface of the portable communications device, e.g., a microphone, a keyboard/keypad, a virtual keyboard/keypad, a writing interface/tablet, a stylus, etc.

Further, the portable communications device can include means for communicatively coupling, via a cloud computing environment (e.g., via an internet based computing environment, via a Transmission Control Protocol (TCP), via an Internet Protocol (IP), etc.) the portable communications device to an educational component in response to the means for receiving the information; and means for displaying, by the portable communications device, e.g., via two or more displays, etc. educational path information, e.g., textbook content, coursework, test(s), teacher comments, homework, material associated with a lesson plan, etc. in response to the means for communicatively coupling the portable communications device to the educational component.

In another example, the portable communications device can include means for communicatively coupling the portable communications device with an instructor interface in response to the means for communicatively coupling the portable communications device to the educational component. In yet another example, the portable communications device can include means for communicatively coupling the portable communications device with a parental interface, and/or means for communicatively coupling the portable communications device with another portable communications device, in response to the means for communicatively coupling the portable communications device to the educational component.

In one example a method can communicatively couple, via a cloud computing environment, an educational component to an educational terminal and an instructor interface. Further, the educational component can receive educational path information, e.g., textbook content, coursework, test(s), teacher comments, homework, material associated with a lesson plan, etc. from the instructor interface, and transfer information, e.g., textbook content, coursework, test(s), teacher comments, homework, material associated with a lesson plan, test/homework/class work responses and/or questions related to a lesson plan, etc. between the educational component and the educational terminal in response to the educational path information.

In another example, the method can communicatively couple, via the cloud computing environment, the educational terminal to a parental interface, the instructor interface, and/or another educational terminal.

The following description and the annexed drawings set forth in detail certain illustrative aspects of the disclosed subject matter. These aspects are indicative, however, of but a few of the various ways in which the principles of the innovation may be employed. The disclosed subject matter is intended to include all such aspects and their equivalents. Other advantages and distinctive features of the disclosed subject matter will become apparent from the following detailed description of the innovation when considered in conjunction with the drawings.

### BRIEF DESCRIPTION OF THE DRAWINGS

Non-limiting and non-exhaustive embodiments of the subject disclosure are described with reference to the following figures, wherein like reference numerals refer to like parts throughout the various views unless otherwise specified.

FIG. 1 illustrates an educational system, in accordance with an embodiment.

FIG. 2 illustrates another educational system, in accordance with an embodiment.

FIG. 3 illustrates yet another educational system, in accordance with an embodiment.

FIG. 4 illustrates an educational environment, in accordance with an embodiment.

FIG. 5 illustrates an educational component, in accordance with an embodiment.

FIG. 6 illustrates an electronic textbook, in accordance with an embodiment.

FIG. 7 illustrates educational resources, in accordance with an embodiment.

FIG. 8 illustrates a testing system, in accordance with an embodiment.

FIG. 9 illustrates a database, in accordance with an embodiment.

FIG. 10 illustrates a school forum, in accordance with an embodiment.

FIG. 11 illustrates a student interface, in accordance with an embodiment.

FIG. 12 illustrates a teacher interface, in accordance with an embodiment.

FIG. 13 illustrates an administrator interface, in accordance with an embodiment.

FIG. 14 illustrates a parent interface, in accordance with an embodiment.

FIGS. 15-16 illustrate various processes associated with an educational system, in accordance with an embodiment.

FIG. 17 illustrates a block diagram of an educational terminal, in accordance with an embodiment.

FIG. 18 illustrates a block diagram of a computing system operable to execute the disclosed methods and apparatus, in accordance with an embodiment.

### DETAILED DESCRIPTION

Various non-limiting embodiments of systems, methods, and apparatus presented herein couple portable educational terminal(s) with an instructor interface by way of an interactive, real-time educational system.

In the following description, numerous specific details are set forth to provide a thorough understanding of the embodiments. One skilled in the relevant art will recognize, however, that the techniques described herein can be practiced without one or more of the specific details, or with other methods, components, materials, etc. In other instances, well-known structures, materials, or operations are not shown or described in detail to avoid obscuring certain aspects.

Reference throughout this specification to “one embodiment,” or “an embodiment,” means that a particular feature, structure, or characteristic described in connection with the embodiment is included in at least one embodiment. Thus, the appearances of the phrase “in one embodiment,” or “in an embodiment,” in various places throughout this specification are not necessarily all referring to the same embodiment. Furthermore, the particular features, structures, or characteristics may be combined in any suitable manner in one or more embodiments.

As utilized herein, terms “component,” “system,” “platform,” “node,” “layer,” “selector,” “interface,” and the like are intended to refer to a computer-related entity, hardware, software (e.g., in execution), and/or firmware. For example, a component can be a processor, a process running on a processor, an object, an executable, a program, a storage device, and/or a computer. By way of illustration, an application running on a server and the server can be a component. One or more components can reside within a process, and a component can be localized on one computer and/or distributed between two or more computers.

Further, these components can execute from various computer readable media having various data structures stored thereon. The components can communicate via local and/or remote processes such as in accordance with a signal having one or more data packets (e.g., data from one component interacting with another component in a local system, distributed system, and/or across a network, e.g., the Internet, with other systems via the signal).

As another example, a component can be an apparatus with specific functionality provided by mechanical parts operated by electric or electronic circuitry; the electric or electronic circuitry can be operated by a software application or a firmware application executed by one or more processors; the one or more processors can be internal or external to the apparatus and can execute at least a part of the software or firmware application. As yet another example, a component can be an apparatus that provides specific functionality through electronic components without mechanical parts; the electronic components can include one or more processors therein to execute software and/or firmware that confer(s), at least in part, the functionality of the electronic components.

The word “exemplary” and/or “demonstrative” is used herein to mean serving as an example, instance, or illustration. For the avoidance of doubt, the subject matter disclosed herein is not limited by such examples. In addition, any aspect or design described herein as “exemplary” and/or “demonstrative” is not necessarily to be construed as preferred or advantageous over other aspects or designs, nor is it meant to preclude equivalent exemplary structures and techniques known to those of ordinary skill in the art. Furthermore, to the extent that the terms “includes,” “has,” “contains,” and other similar words are used in either the detailed description or the claims, such terms are intended to be inclusive—in a manner similar to the term “comprising” as an open transition word—without precluding any additional or other elements.

Artificial intelligence based systems, e.g., utilizing explicitly and/or implicitly trained classifiers, can be employed in connection with performing inference and/or probabilistic determinations and/or statistical-based determinations as in accordance with one or more aspects of the disclosed subject matter as described herein. For example, an artificial intelligence system can be used, via instructor interface 130 (see below), to automatically track, via a network computing environment and/or a cloud computing environment, tracking information, e.g., a location of an educational terminal, information related to a lesson plan, student related performance, etc. In another example, the artificial intelligence system can automatically select individualized lesson plan(s) for respective students in response to the tracking information.

As used herein, the term “infer” or “inference” refers generally to the process of reasoning about, or inferring states of, the system, environment, user, and/or intent from a set of observations as captured via events and/or data. Captured data and events can include user data, device data, environment data, data from sensors, sensor data, application data, implicit data, explicit data, etc. Inference can be employed to identify a specific context or action, or can generate a probability distribution over states of interest based on a consideration of data and events, for example.

Inference can also refer to techniques employed for composing higher-level events from a set of events and/or data. Such inference results in the construction of new events or actions from a set of observed events and/or stored event data, whether the events are correlated in close temporal proximity, and whether the events and data come from one or several event and data sources. Various classification schemes and/or systems (e.g., support vector machines, neural networks, expert systems, Bayesian belief networks, fuzzy logic, and data fusion engines) can be employed in connection with performing automatic and/or inferred action in connection with the disclosed subject matter.

In addition, the disclosed subject matter can be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, computer-readable carrier, or computer-readable media. For example, computer-readable media can include, but are not limited to, magnetic storage devices, e.g., hard disk; floppy disk; magnetic strip(s); optical disk (e.g., compact disk (CD), digital video disc (DVD), Blu-ray Disc™ (BD)); smart card(s); and flash memory device(s) (e.g., card, stick, key drive); and/or a virtual device that emulates a storage device and/or any of the above computer-readable media.

Aspects, features, and/or advantages of the disclosed subject matter can be exploited in substantially any wireless telecommunication or radio technology, e.g., wireless fidelity (Wi-Fi™); Bluetooth™, Worldwide Interoperability for Microwave Access (WiMAX™); Enhanced General Packet Radio Service (Enhanced GPRS); Third Generation Partnership Project (3GPP) Long Term Evolution (LTE™); Third Generation Partnership Project 2 (3GPP2); Ultra Mobile Broadband (UMB); 3GPP Universal Mobile Telecommunication System (UMTS); High Speed Packet Access (HSPA); High Speed Downlink Packet Access (HSDPA); High Speed Uplink Packet Access (HSUPA); LTE™ Advanced (LTE-A), Global System for Mobile Communication (GSM), Near Field Communication (NFC), etc.

The subject disclosure relates to systems, methods, and apparatus associated with an interactive, real-time educational system. As described above, conventional educational technologies lack digital teaching aids oriented towards efficient instruction. Compared to such technologies, various systems, methods, and apparatus described herein facilitate improved instruction by coupling one or more portable educational terminals with an instructor interface by way of the interactive, real-time educational system.

Aspects of systems, apparatus, and processes explained herein can constitute machine-executable instructions embodied within a machine, e.g., embodied in a computer readable medium associated with the machine. Such instructions, when executed by the machine, can cause the machine to perform the operations described. Additionally, the systems and processes can be embodied within hardware, such as an application specific integrated circuit (ASIC) or the like. Moreover, the order in which some or all of the process blocks appear in each process should not be deemed limiting. Rather, it should be understood by a person of ordinary skill in the art having the benefit of the instant disclosure that some of the process blocks can be executed in a variety of orders not illustrated.

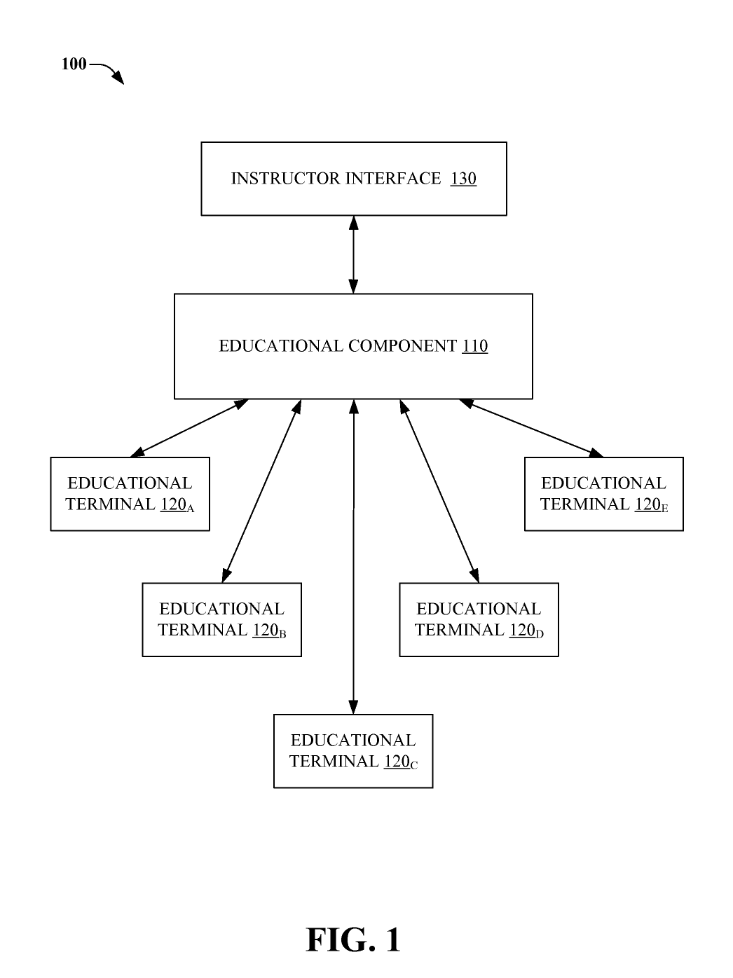

Now referring to FIG. 1, an educational system 100 is illustrated, in accordance with an embodiment. Educational system 100 can include an educational component 110, which can provide an interactive, real-time, learning resource to educational terminal(s) within a classroom environment, e.g., school, university, etc. For example, educational system 100 can include server(s), computing device(s), etc. that can be coupled to at least one database. Further, educational system 100 can authorize a first communication between educational component 110 and educational terminals 120_{A-E}, e.g., utilizing the server(s) and the at least one database, within a network computing environment, e.g., via TCP/IP based technology, the Internet, cloud computing environment, etc.

In an aspect, the first communication can include a log-in event, for example, requiring an alphanumeric registration, voice activated registration, or biometric registration from an associated educational terminal. In another aspect, the educational terminal can include more than one display and more than one input device. For example, the educational terminal can include two screens representing respective pages of a text book. Further, the educational terminal can include an input device, notepad, virtual keyboard, etc. to receive information associated with the log-in event, student responses, etc.

Educational component 110 can further authorize, via the network computing environment, a second communication between educational component 110 and an instructor interface 130. In an aspect, the second communication can include a log-in event, for example, requiring an alphanumeric registration, voice activated registration, or biometric registration from instructor interface 130. In another aspect, the second communication can include information, e.g., stored in the database, and associated with a lesson plan, instructional material, classroom communication, etc. that can be customized towards a student of a respective educational terminal.

For example, educational component 110 can transfer, via the network computing environment, educational path information between an educational terminal, e.g., 120_{A}, 120_{B}, 120_{C}, 120_{D}, 120_{E}, etc. and educational component 110 in response to the second communication. For example, the educational path information can include digitized textbook information, individualized instructional material, e.g., related to a lesson plan associated with the educational terminal, student response(s), etc.

In another aspect, educational component 110 can authorize, via the network computing environment, a communication between instructor interface 130 and the educational terminal, e.g., 120_{A}, 120_{B}, 120_{C}, 120_{D}, 120_{E}, etc. In an aspect, the communication can include information and/or feedback related to coursework, e.g., of a lesson plan, etc. communicated from the instructor interface to the educational terminal. In another aspect, the communication can include questions, messages, information, etc. sent from a student associated with the educational terminal to an instructor (via instructor interface 130).

In yet another aspect, instructor interface 130 can include a teacher private office, which can host the teacher's timetable, and include class registers of classes taught by the teacher. Instructor interface 130 can also include a teacher private archive, which can host additional teaching materials, as well as confidential data about students, personal observations, conclusions, etc. In one aspect, instructor interface 130 can include: tools to monitor student progress in each class; tools to obtain test materials; tools to obtain test reports on questions that are checked automatically; tools to convert test results into a five-grade mark; tools to deliver the final class-by-class mark to the class register and to the grade book; tools to enter comments on completed tasks; and tools to deliver comments to students, their parents, school administration, etc.

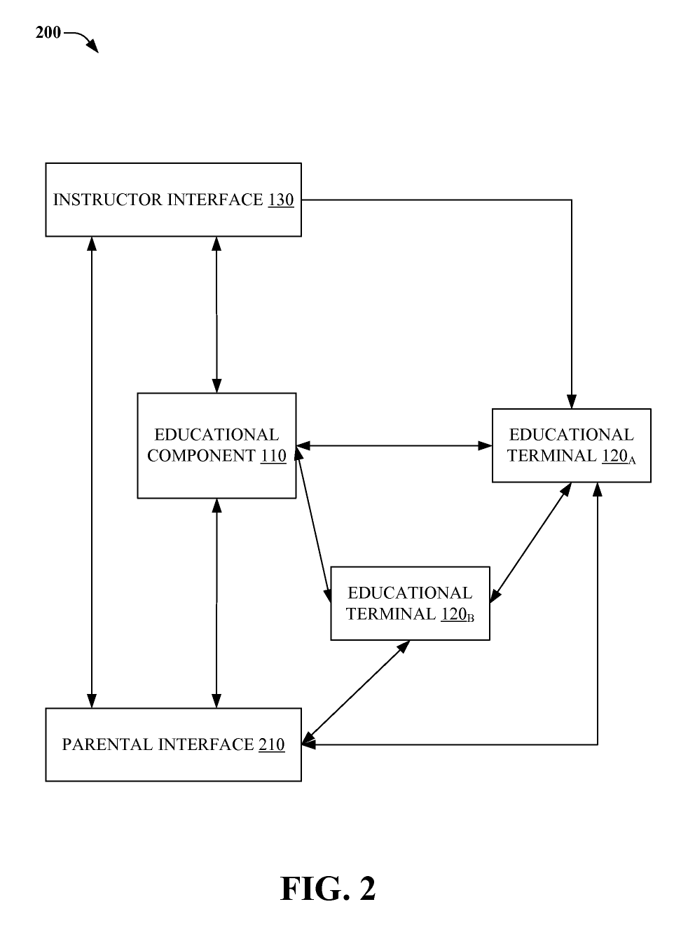

Referring now to FIG. 2, an educational system (200) including a parental interface 210 is illustrated, in accordance with an embodiment. Educational component 110 can authorize, via the network computing environment, a communication between parental interface 210 and educational component 110, instructor interface 130, and/or the educational terminal, e.g., 120_{A}, 120_{B}. For example, the communication can include information sent from a teacher (via instructor interface 130) to a parent (via parental interface 210) related to progress of a student associated with the educational terminal, e.g., student progress and/or performance related to one or more lesson plans, etc. In another example, the parent can request final marks of their child's performance at the end of each class, a screenshot of their progress in class, e.g., during a current term, semester, school year, etc.

In yet another example, educational component 110 can authorize a communication between parental interface 210 and the educational terminal, e.g., rescheduling a time a parent will pickup their child after school, etc. In another example, educational component 110 can authorize, via the network computing environment, a communication between the educational terminal and another educational terminal, e.g., a communication between students, a communication via a wiki forum, a blog, etc. It should be appreciated that educational component 110 can restrict communications between educational terminals, between parental interface 210 and educational terminals, etc. during examination periods, etc.

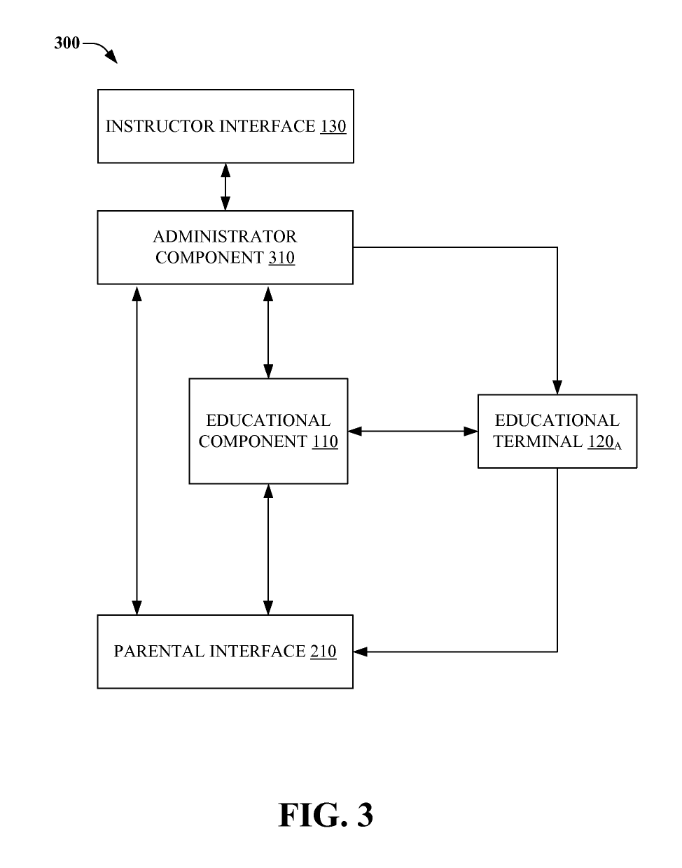

FIG. 3 illustrates an educational system 300 including an administrator component 310, in accordance with an embodiment. Educational component 110 can authorize, via the network computing environment, a communication between administrator component 310 and educational component 110, instructor interface 130, parental interface 210, and/or the educational terminal, e.g., 120_{A}, 120_{B}. In an aspect, the communication can relate to changes in schedule of indoor and/or outdoor events, weather related information affecting school closure, etc.

In another aspect, instructor interface 130 can track, via the network computing environment, tracking information associated with the educational path information. As described above, the tracking information can be automatically tracked, recorded, etc. in a database. In one aspect, the tracking information can include a location of the educational terminal (e.g., to verify attendance of an associated student) and/or information related to a lesson plan. In another aspect, instructor interface 130 can select the educational path information, e.g., a lesson plan, incentive(s), assistance, etc. in response to the tracking information. For example, a student who has far exceeded lesson plan performance expectations can be “loaded” with (or sent) addition tasks.

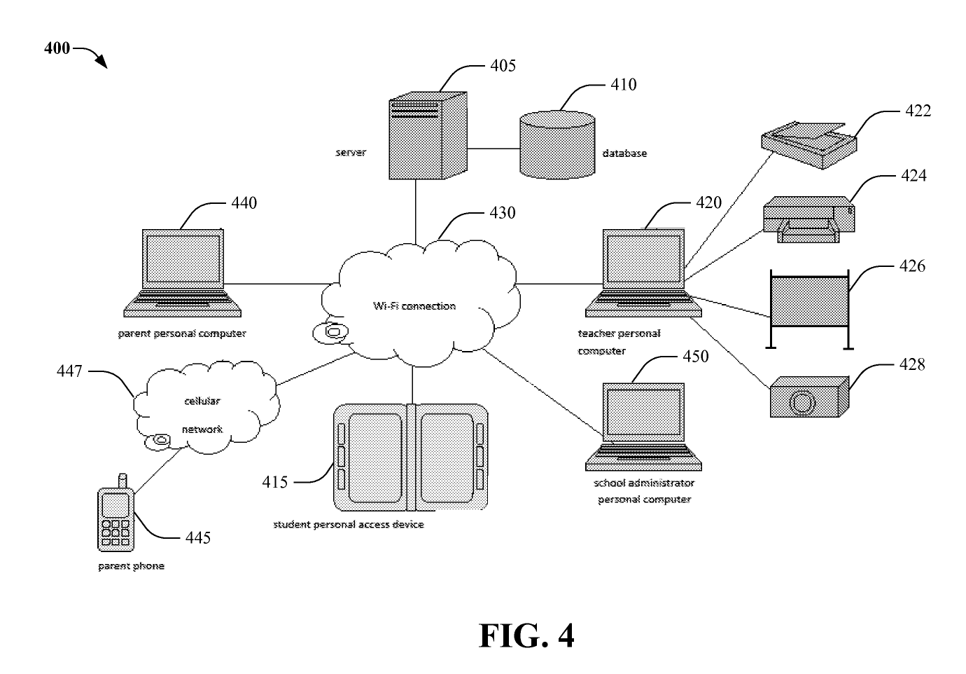

Now referring to FIG. 4, an educational environment 400 is illustrated, in accordance with an embodiment. Server 405 can couple to database 410 (forming, for example, educational component 110). Database 410 can store lesson plan info, etc. and can be accessed via Internet 430, e.g., via a Wi-Fi connection, a local area network (LAN) (not shown), a cloud computing environment (not shown), etc.

Educational component 110 can be accessed, via Internet 430, from student personal access device 415 (e.g., educational terminal 120_{A}), teacher personal computer 420 (e.g., instructor interface 130); school administrator personal computer 450 (e.g., administrator component 310); and parent personal computer 440 (e.g., parental interface 210). Further, as illustrated by FIG. 4, educational component 110 can be accessed from a parent phone 445 via a cellular network 447.

Student personal access device 415 can include a computing device with two sensor screens, e.g., which can present pages of an electronic textbook, and/or receive student responses entered, for example, from a virtual keyboard, stylus, etc. Further, student personal access device 415 can convert student input, e.g., notes, answers, drawings, graphs, diagrams, sketches, etc. detected by input device(s), the sensor screens, etc. of student personal access device 415, e.g., into information, e.g., text and/or images, etc. that can be communicated to educational component 110 and/or instructor interface 130.

Teacher personal computer 420 can collect such information, e.g., received from student personal access device 415, received from educational component 110, etc. and perform initial processing, lesson plan selection, etc. based on the collected information. Further, teacher personal computer 420 can utilize various peripherals, e.g., a scanner 422, a printer 424, an electronic board 426, a projector 428, etc. to enhance classroom instruction, e.g., in response to the collected information.

In an aspect, a teacher, via teacher personal computer 420, can assign students to educational path(s). During a class, each student, utilizing his/her student personal access device 415, can read class text, receive information from the teacher about his/her assigned educational path, e.g., on a color screen, and/or review information during his/her independent work along his/her assigned educational path. In one example, educational component 110 can control Internet resources available to a student, e.g., for performing research, etc. The student can utilize an associated student personal access device 415 to review texts, slides, photographs, reproductions, audio, video, etc.

In another aspect, educational component 110 can enable the student to perform test(s) associated with his/her assigned educational path; review test results; present material/information to a class and/or the teacher; save class related information in an electronic folder and/or portfolio associated with the student (e.g., stored in database 410); answer questions automatically checked during a class, and present answer(s) to questions presented to the student during the class), etc. The teacher can review student performance utilizing an interactive electronic board displaying educational paths assigned to respective students. Further, students can collaborate on projects, discussions, etc. utilizing wiki technology.

In yet another aspect, the teacher can monitor on display(s) of teacher personal computer 420, e.g., via a screenshot indicating student transitions from one educational path, layer, etc. to another educational path, layer, etc. student progress (e.g., displayed via different colors) as educational path tasks are completed by respective students. In one aspect, the teacher can communicate, via respective personal access devices 415, additional tasks for students (who progressed during their independent work associated with an educational path) to complete. In another aspect, the teacher can communicate incentives and/or instructional assistance to students who have not started their respective coursework, tasks, etc. and/or who request assistance.

In one aspect, the teacher can submit feedback received from respective students of a class to the class; and/or can submit text, diagram(s), photo(s), audio, video(s), etc. to the class. In another aspect, educational component 110 can grant students unrestricted Internet access, via respective personal access devices 415, to educational resources, e.g., including full versions of electronic books, archived educational material, museum/art/photo exhibitions, etc. In yet another aspect, educational component 110 can limit, e.g., during class, student Internet access via respective personal access devices 415.

As described above, educational component 110 can enable an instructor, teacher, etc. to differentiate and/or individualize instructional material, e.g., by directing students along educational paths of different difficulty levels, via respective personal access devices 415. Further, educational component 110 can enable the instructor to maintain, e.g., via database 410, individual profiles of each student, for example, as dynamically changing graph(s) recording and/or presenting student progress.

Furthermore, in addition to integrating use of digital textbooks within a classroom environment, educational environment 400 can provide each student with enhanced learning tools. For example, the teacher can associate an educational path number with each student's name, and educational component 110 can automatically monitor, via the educational path number, student progress and inform the teacher of such progress, e.g., indicating whether a student is reading an educational path task, is utilizing an educational resource associated with the educational path task, is performing a test associated with the educational path, is reviewing an electronic textbook, etc. Utilizing such information, the teacher can check test results and homework, send note(s) and/or comment(s) to students, provide differentiated instructional material to each student, etc.—enabling each student to progress along the instructional material at his/her pace and/or level of difficulty.

In another example, educational environment 400 can effectively enable educational content updates via electronic media, textbooks, etc. that are, e.g., related to changes in science, for example, exclusion of Pluto from the class of planets; language reform; changes in a sociopolitical situation, e.g., a change in number of constituent members of the Russian Federation; a change in the number of time zones; a change in education standards, etc.

In yet another example, educational environment 400 can enable, e.g., via school administrator personal computer 450, educational authorities, e.g., federal, oblast, city, district, school, etc. to monitor school, student, and/or instructor performance. Further, educational environment 400 can facilitate more efficient instruction by integrating and providing, via student personal access devices 415, numerous informational resources associated with, e.g., text(s), museum(s), one or more libraries, etc. in a classroom environment.

In one aspect, a student personal access device 415 can include an internet-ready (or network capable) camera and/or microphone for use with internet-based (or network-based) services, e.g., associated with remote group instruction. In another aspect, such component(s) can be utilized with voice and/or video over internet protocols during an academic and/or instructional activity occurring, e.g., away from a classroom, etc.

For example, the student personal access device 415 can enable students to participate in a classroom/instructional activity associated with a scientific experiment conducted away from the classroom, e.g., conducted in a specialized research facility located, for example, thousands of miles away from the classroom; conducted in a laboratory of a school, etc. As such, the internet-ready camera and/or microphone can enable students to actively participate, e.g., ask/answer questions, view laboratory experiments, etc. in a real-time, remote learning environment via student personal access device 415.

In another example, the student personal access device 415 can enable student(s) to collaborate and/or participate in classroom associated tasks remote from a classroom, e.g., share dialogues related to foreign language lessons; exchange classroom material and/or project information during off-hours; participate in a classroom lesson at home while ill, injured, etc.

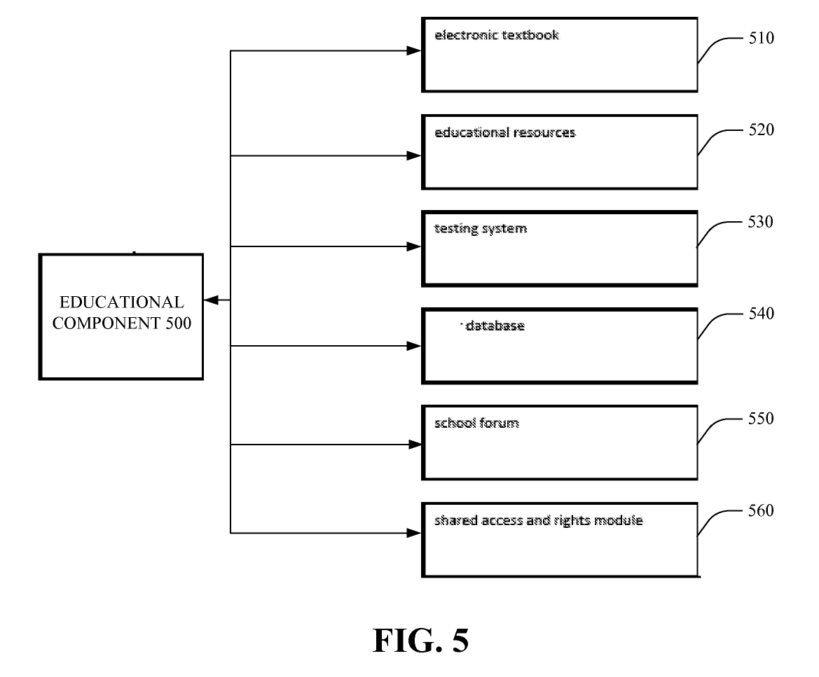

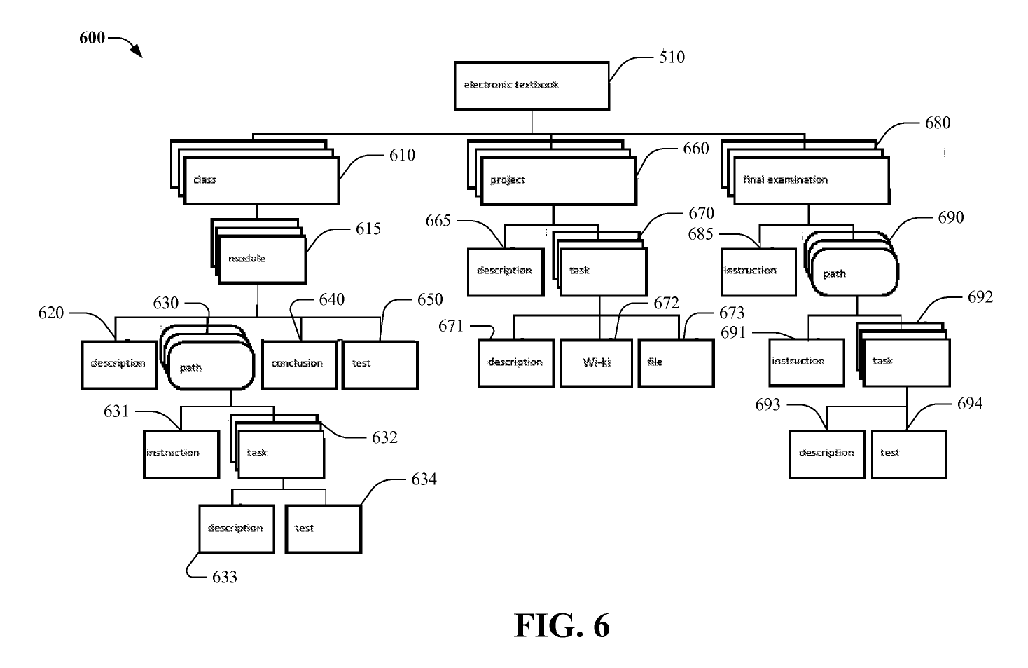

FIG. 5 illustrates an educational component 500 (e.g., 110), in accordance with an embodiment. Educational component 500 can include electronic textbook 510, educational resources 520, testing system 530, database 540, school forum 550, and shared access and rights module 560. Now referring to FIG. 6, an electronic textbook 510 is illustrated, in accordance with an embodiment. Electronic textbook 510 can include class 610, project 660; and final examination 680.

A lesson plan related to electronic textbook 510 can be associated with a section number and a sequence number. Each section can be associated with a home page, and can include block(s) and associated resource(s). For example, a section can include blocks of different levels (e.g., level_{—}1, level_{—}2, level_{—}3, etc.) and resources. In another example, a section of electronic textbook 510 can include two types of blocks: a type of block associated with a parallel structure and another type of block associated with a consequential structure. A block with the parallel structure has a home page, which functions as an option distributor. A block with the consequential structure does not have a home page.

A module 615 is a block of the consequential structure, and can be used to determine class stages. A path (630, 690, etc.) is a block with the parallel structure, and can be used to determine individual educational paths of students at each class stage. A task (632, 670, 692, etc.) is a block with the consequential structure. It is used to determine stages completed by students during individual educational paths, qualification papers/exams, etc.

Resources of a section of electronic textbook 510 can represent pages of several types, which can differ by a set of assigned attributes, e.g., elements of data storage. Further, types of resources can include a description (620, 633, 665, 671, 691, 693, etc.), which can be a page designed for writing text, illustrating figures, tables, graphs, etc. Another type of resource, a conclusion 640, is a page designed for writing/authoring text(s) with various highlight(s), e.g., with various fonts, markers, colors, etc. This text can be furnished with illustrations. Further, conclusion 640 can include a hyperlink to a home page of a class section.

Yet another type of resource, instruction (631, 685, 691, etc.) is a page designed for writing/authoring texts and multilevel lists. The page may have a hyperlink to sections of educational resources 520 and can be furnished with illustrations. File 673 is a resource that can be attached, e.g., as a file, in a particular format, e.g., text, audio, etc. The file can represent, e.g., information created and/or presented by students; links to Internet page(s); individual student results, etc. Further, the file can be viewed by a student, sent to a teacher for review/verification, sent to the teacher for demonstration, or saved to a portfolio/folder of the student.

Test (634, 650, 694, etc.) is a page designed for writing text furnished with illustrations, e.g., figures, tables, graphs, etc. and control elements, e.g., ActiveX. Wi-ki 672 is a page created by several students simultaneously that can include text, multilevel lists, illustrations, hyperlinks to sections of educational resources 520, web pages, etc.

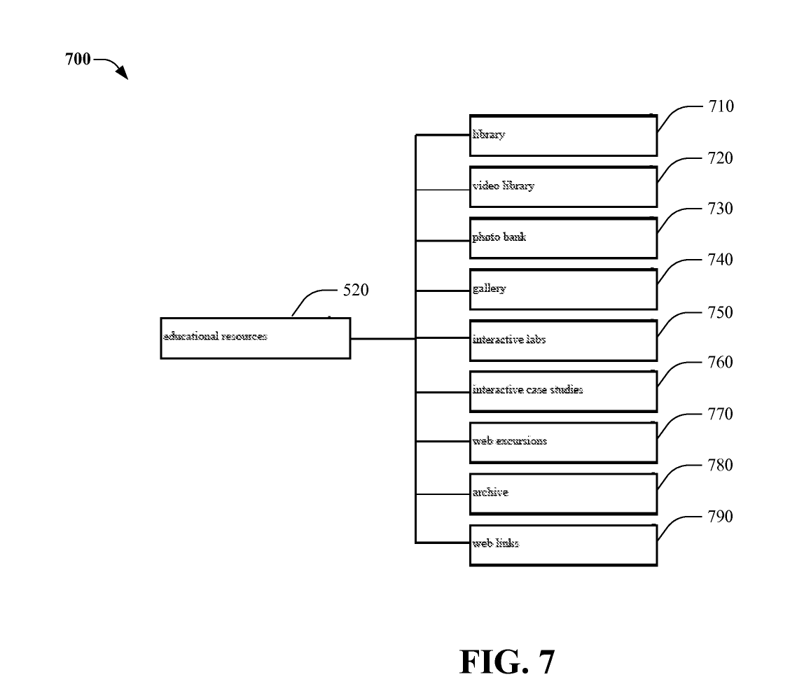

FIG. 7 illustrates educational resources 520, in accordance with an embodiment. Educational resources 520 can include a library 710; a video library 720; a photo bank 730; a gallery 740; interactive labs 750; interactive case studies 760; web excursions 770; archive 780; and web links 790. Interactive labs 750 and interactive case studies 760 can include an upper level educational area-based distribution and a lower level alphabetically-based distribution. Library 710 and archive 780 enable students and/or instructors to mark and/or copy text fragments. Video library 720 and web excursions 770 enable capture, e.g., of a photograph, snapshot, etc. of video fragment(s) that are viewed by an instructor and or a student. Photo bank 730 and gallery 740 enable creation of presentations. Web links 790 include links to web pages relevant to a lesson plan.

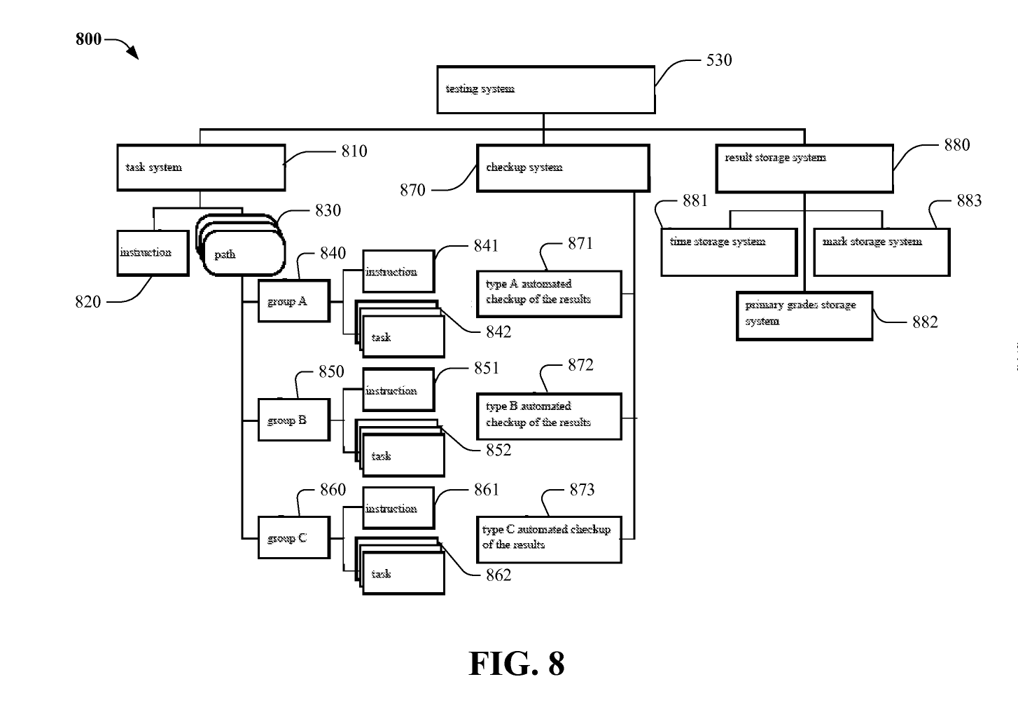

FIG. 8 illustrates a testing system 530, in accordance with an embodiment. Testing system 800 can include a task system 810 section, a checkup system 870 section, and a result storage system 880 section. Such sections can have a home page, which can function as an option distributor. A section can include blocks of different levels (e.g., level_{—}1, level_{—}2, etc.), resources, and an automated checkup system. Task system 810 can include, as resource(s), instruction 820 and parallel block paths 830. Paths 830 can include three groups: group A 840; group B 850; and group C 860. Each group can include an instruction resource, e.g., 841, 851, and 861, respectively. Further, each group can include a consequential block task, e.g., 842, 852, and 862, respectively.

Checkup system 870 can include three types of automated checkup of results related to tasks of task system 810—such results can be documented as primary grades. Result storage system 880 is a database that can include a time storage system 881, a primary grade storage system 882, and a mark storage system 883. Time storage system 881 can include data related to a time of execution of each task 842, 852, and 862 associated with group A 840, group B 850, and group C 860, respectively. Primary grade storage system 882 can include primary grades received during an automated checkup of each task 842, 852, and 862. Mark storage system 883 can include marks received as the result of converting primary grades according to preset conformity scales, e.g., specific to educational area(s).

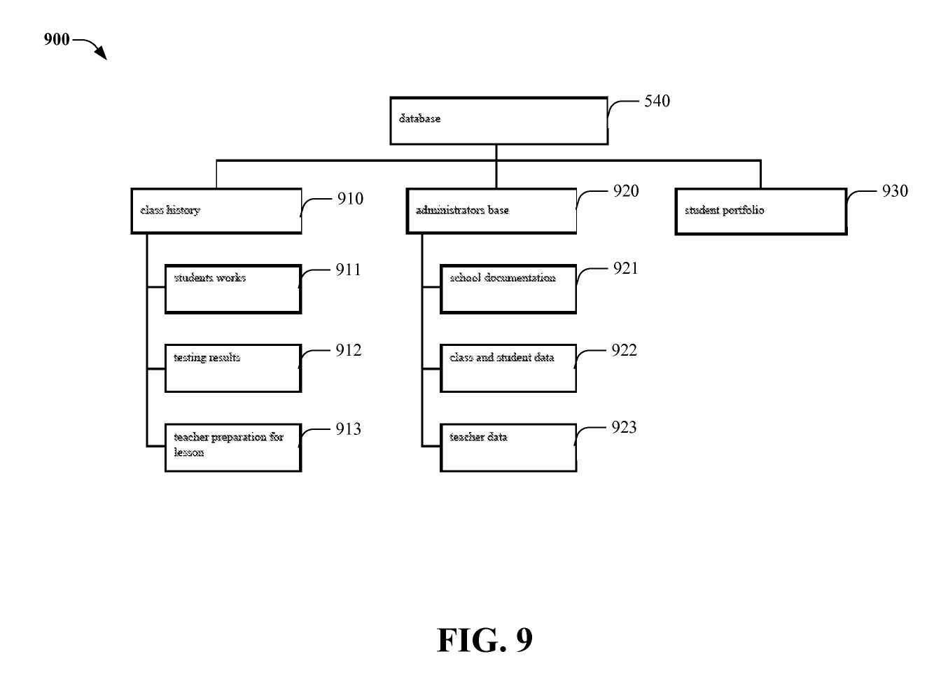

FIG. 9 illustrates a database 540, in accordance with an embodiment. Database 540 can include class history 910, administrators base 920, and student portfolios 930. Class history 910 is a database that can include primary results related to electronic learning, e.g., including student works 911 (related to student coursework), testing results 912 (related to student exam results), and teacher preparation for lesson 913 section (related to teacher lesson material related to a lesson plan). Administrators base 920 can include data about: a school (school documentation 921); students (class and student data 922); teachers (teacher data 923); and/or parents. Student portfolio 930 can include information on student individual work, as well as results of student collaborative work.

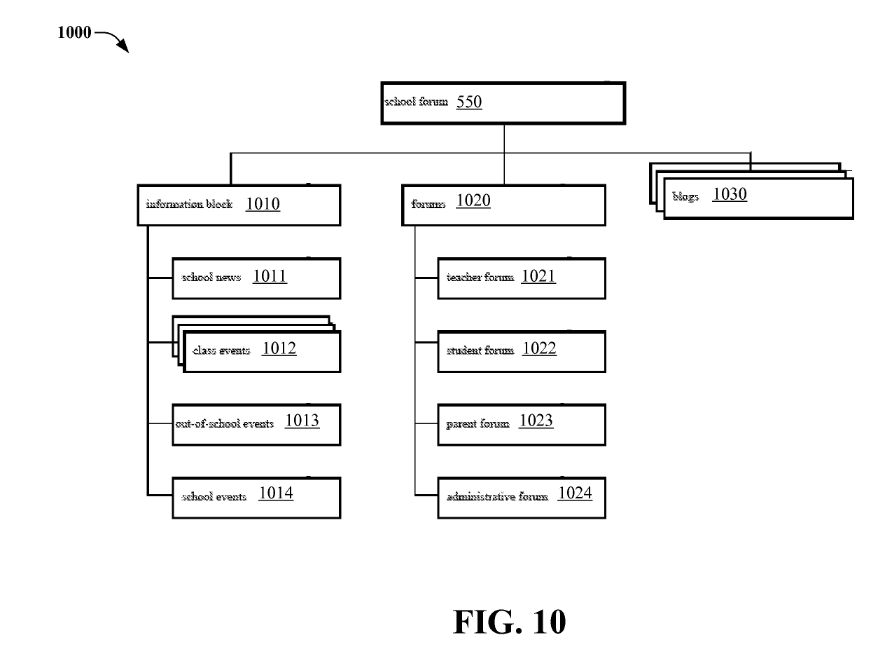

FIG. 10 illustrates a school forum 550, in accordance with an embodiment. School forum 550 can include information 1010; forums 1020; and blogs 1030. Information 1010 can include school news 1011 and information regarding class events 1012, out-of-school events 1013, and school events 1014. Forums 1020 can include a teacher forum 1021, a student forum 1022, a parent forum 1023, and an administrator forum 1024. Blogs 1030 can include a social network of students, parents, teachers, etc. within and between schools.

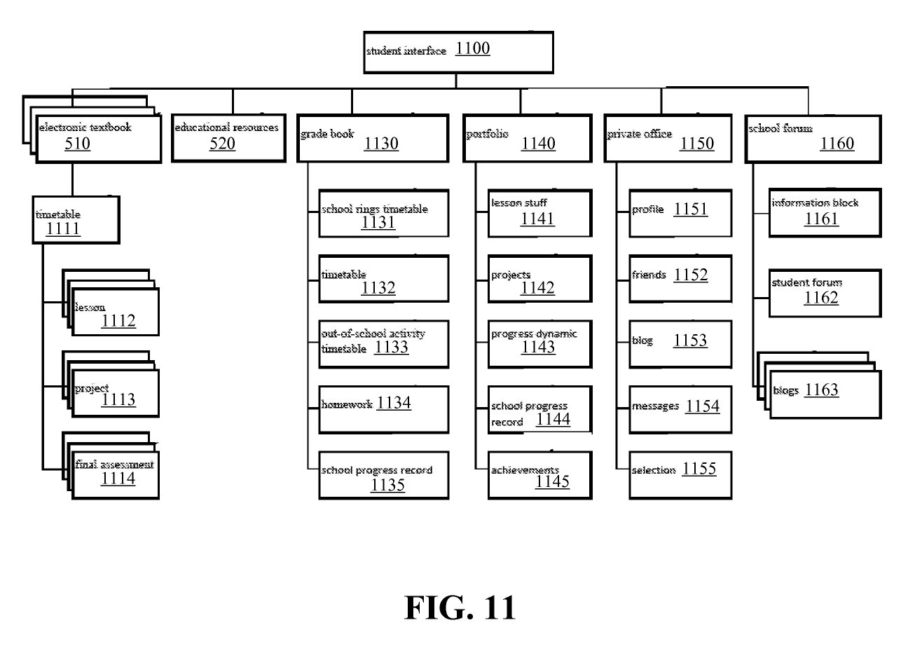

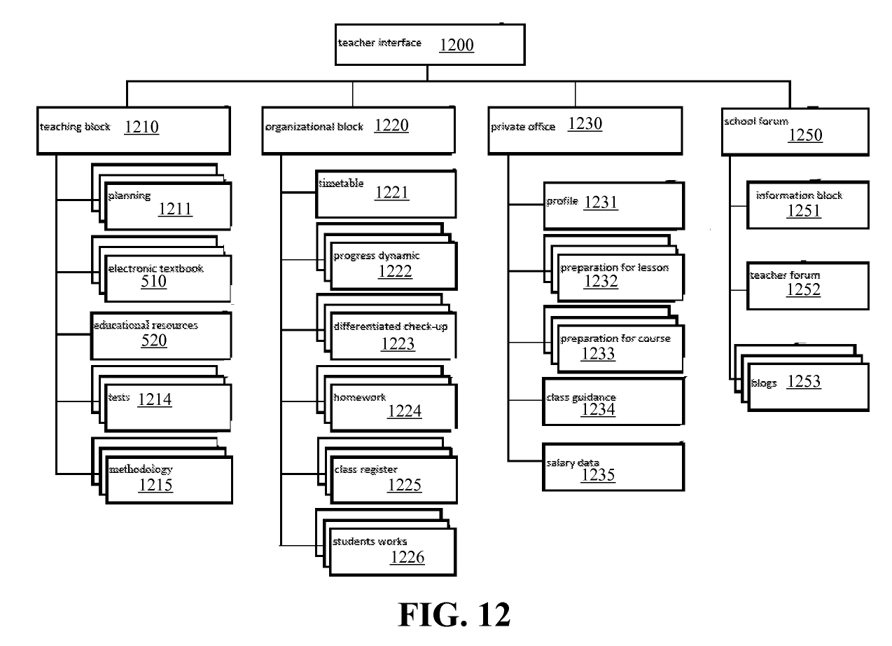

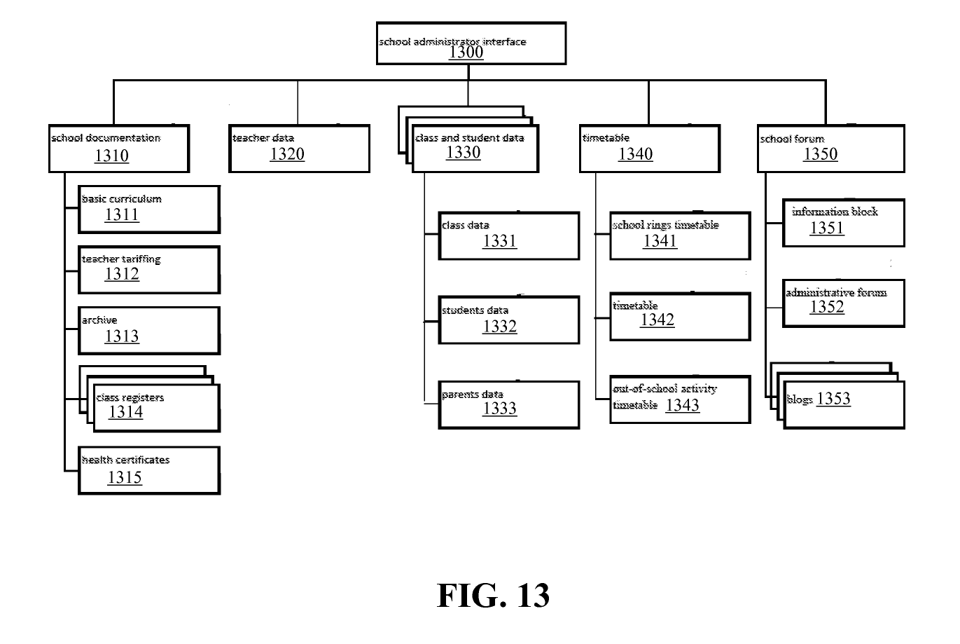

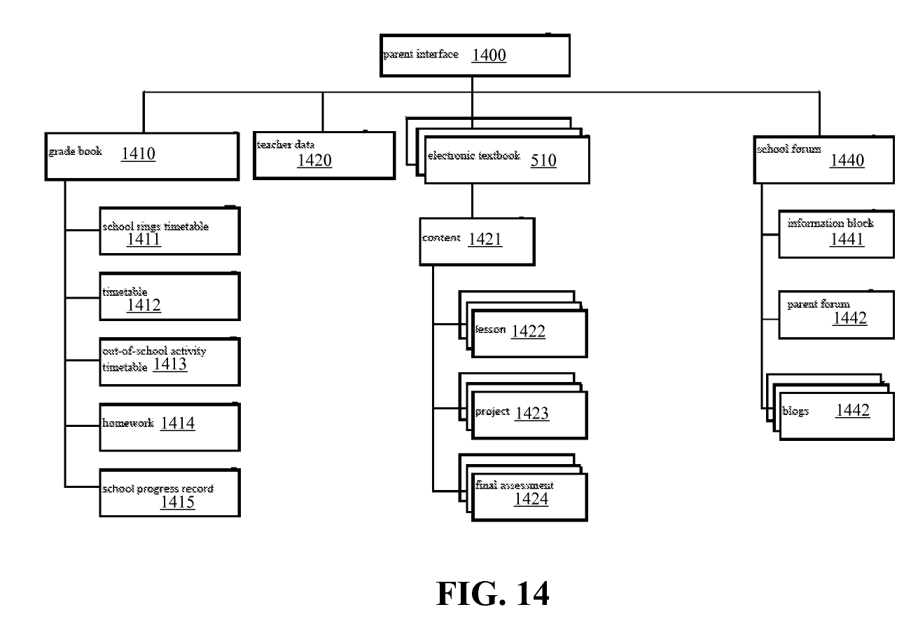

FIGS. 11-14 illustrate a student interface 1100, a teacher interface 1200, a school administrator interface 1300, and a parental interface 1400, respectively, in accordance with one or more embodiments. Such interfaces can be included in shared access and rights module 560. As illustrated by FIG. 11, student interface 1100 can include electronic textbook 510, educational resources 520, grade book 1130, portfolio 1140, private office 1150, and school forum 1160. Electronic textbook can include timetable 1111, lesson 1112, project 1113, and final assessment 1114. Grade book 1130 can include school rings timetable 1131, timetable 1132, out-of-school activity timetable 1133, homework 1134, and school progress record 1135. Portfolio 1140 can include lesson information 1141, projects 1142, progress dynamic 1143, school progress record 1144, and achievements 1145. Private office 1150 can include profile 1151, friends 1152, blog 1153, messages 1154, and selection 1155. School forum 1160 can include information block 1161, student forum 1162, and blogs 1163.

Teacher interface 1200 can include teaching block 1210, organizational block 1220, private office 1230, and school forum 1250. Teaching block 1210 can include planning block 1211, electronic textbook 510, educational resources 520, tests 1214, and methodology 1215. Organizational block 1220 can include timetable 1221, progress dynamic 1222, differentiated check-up 1223, homework 1224, class register 1225, and students works 1226. Private office 1230 can include profile 1231, preparation for lesson 1232, preparation for course 1233, class guidance 1234, and salary data 1235. School forum 1250 can include information block 1251, teacher forum 1252, and blogs 1253.

School administrator interface 1300 can include school documentation 1310, teacher data 1320, class and student data 1330, timetable 1340, and school forum 1350. School documentation 1310 can include basic curriculum 1311, teacher tariffing 1312, archive 1313, class registers 1314, and health certificates 1315. Class and student data 1330 can include class data 1331, students data 1332, and parents data 1333. Timetable 1340 can include school rings timetable 1341, timetable 1342, and out-of-school activity timetable 1343. School forum 1350 can include information block 1350, administrative forum 1352, and blogs 1353.

Parent interface 1400 can include grade book 1410, teacher data 1420, electronic textbook 510, and school forum 1440. Grade book 1410 can include school rings timetable 1411, timetable 1412, out-of-school activity timetable 1413, homework 1414, and school progress record 1415. Electronic textbook 510 can include content 1421, lesson 1422, project 1423, and final assessment 1424. School forum can include 1440, information block 1441, parent forum 1442, and blogs 1442.

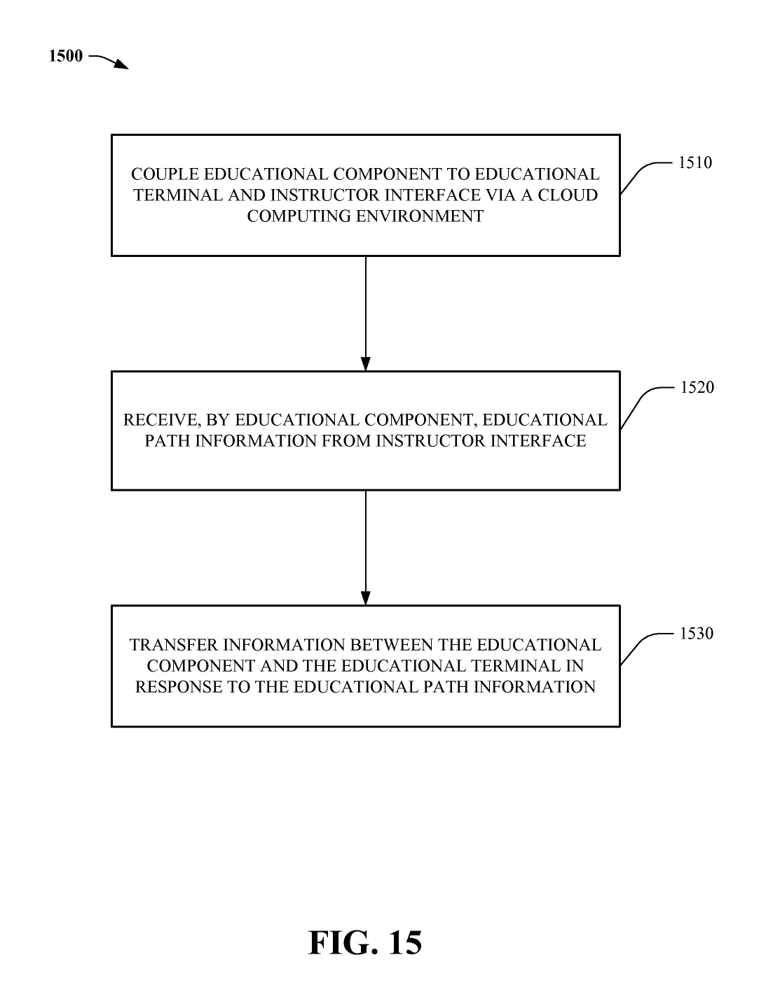

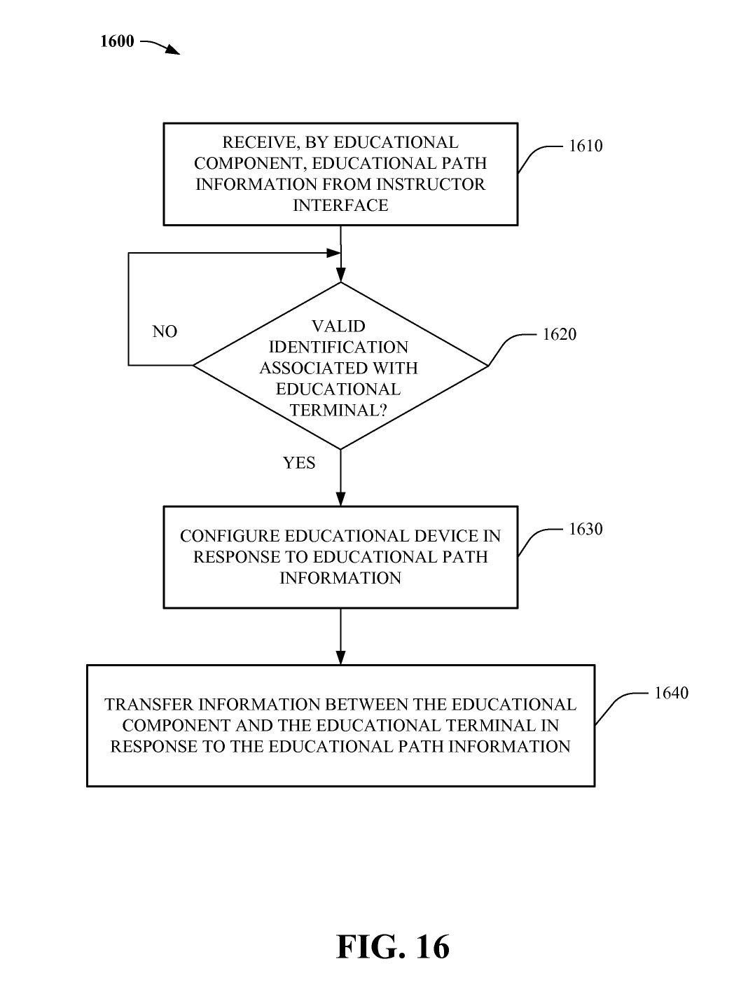

FIGS. 15-16 illustrate various processes performed by an educational system, e.g., 100, 200, 300, 400, etc. in accordance with the disclosed subject matter. For simplicity of explanation, the methodologies are depicted and described as a series of acts. It is to be understood and appreciated that the subject innovation is not limited by the acts illustrated and/or by the order of acts. For example, acts can occur in various orders and/or concurrently, and with other acts not presented or described herein. Furthermore, not all illustrated acts may be required to implement the methodologies in accordance with the disclosed subject matter. In addition, those skilled in the art will understand and appreciate that the methodologies could alternatively be represented as a series of interrelated states via a state diagram or events. Additionally, it should be further appreciated that the methodologies disclosed hereinafter and throughout this specification are capable of being stored on an article of manufacture to facilitate transporting and transferring such methodologies to computers. The term article of manufacture, as used herein, is intended to encompass a computer program accessible from any computer-readable device, carrier, or media.

Referring now to FIG. 15, a process 1500 associated with an educational system is illustrated, in accordance with an embodiment. At 1510, an educational component (110) can be communicatively coupled to an educational terminal (120_{A}, 120_{B}, etc.) and an instructor interface (130) via a secure, or password protected, cloud computing environment. In an aspect, the educational component can be communicatively coupled to the instructor interface and the educational terminal via different wireless protocols, such as Wi-Fi™, WiMAX™, Bluetooth™ 3GPP, 3GPP2, LTE™, LTE™ Advanced, UMTS, GSM, NFC, etc.

At 1520, educational path information (see above) sent from the instructor interface can be received by the educational component. At 1530, information, e.g., information related to a lesson plan, etc. can be transferred, communicated, etc. between the educational component and the educational terminal in response to the educational path information.

FIG. 16 illustrates another process (1600) associated with an educational system, in accordance with an embodiment. At 1610, an educational component (110) can receive educational path information from an instructor interface (130). At 1620, process 1600 can determine, e.g., via educational component 110, whether an identification, e.g., password protected login, etc. associated with an educational terminal is valid. If process 1600 determines that the identification is valid, the educational component can configure the educational device, at 1630, in response to the educational path information. Information related to a lesson plan, e.g., instructional material, test(s), correspondence, etc. can be transferred between the educational component and the educational terminal in response to the educational path information.

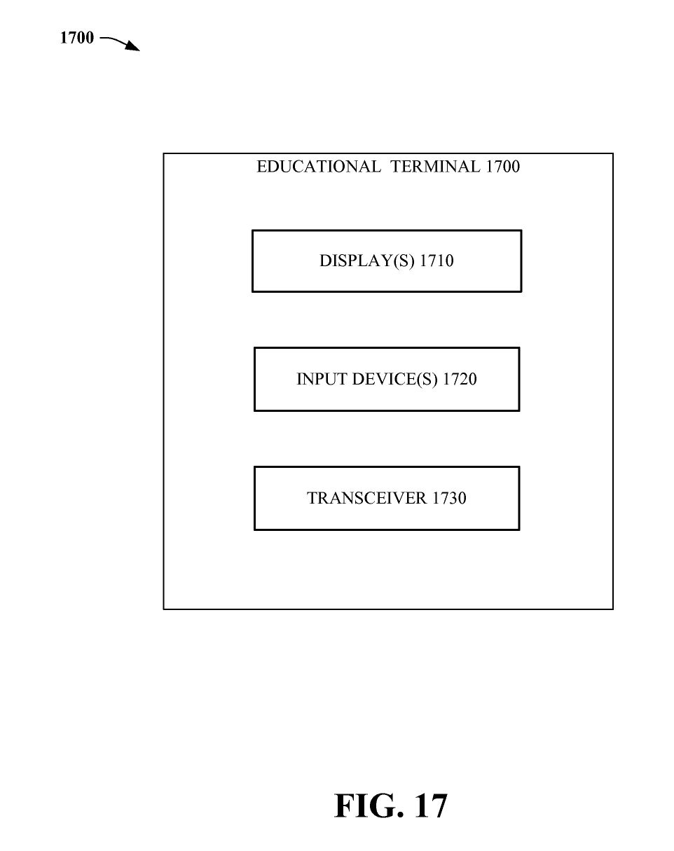

Referring now to FIG. 17, an educational terminal 1700 (e.g., 120_{A-E}, 415, etc.) is illustrated, in accordance with an embodiment. Educational terminal can be associated with an identification number, e.g., IP address, password, etc. by which an educational component (110) can use to communicatively couple to the educational terminal Further, in an aspect, the educational component can utilize Global Positioning System (GPS) navigation techniques to locate the educational terminal, e.g., to verify attendance of an associated student. In one aspect, educational terminal 1700 (or student terminal) can include a personal student portfolio (1140); tools (520, 1130, etc.) to represent, save, transfer, automatically check, etc. answers to questions associated with an educational path, tests, etc. and can include tools to receive teacher comments.

In an aspect, display(s) 1710 can include at least two screens, e.g., a black-and-white screen utilized as an e-book, electronic book, etc. and a color, liquid-crystal display (LCD) utilized to communicate lesson plan information. Input device(s) 1720 can include various mechanical and/or virtual input devices, e.g., a keyboard, a virtual keyboard, a virtual writing pad, a microphone, etc. from which educational terminal 1700 can receive student input, e.g., answers to test questions, questions/comments related to a lesson plan, etc. Transceiver 1730 can include a wireless transmitter and receiver that can transmit/receive lesson plan information, student input, etc. to/from the educational terminal utilizing, e.g., Wi-Fi™, WiMAX™, Bluetooth™, 3GPP, 3GPP2, LTE™, LTE™ Advanced, UMTS, GSM, NFC, etc.

In one aspect described above, educational terminal 1700 can include an internet-ready (or network capable) camera and/or microphone for use with internet-based (or network-based) services, e.g., associated with remote group instruction. In another aspect, such device(s) can be utilized with voice and/or video over internet protocols during an academic and/or instructional activity occurring, e.g., away from a classroom, etc.

As it is employed in the subject specification, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, or any combination thereof designed to perform the functions and/or processes described herein. Processors can exploit nano-scale architectures such as, but not limited to, molecular and quantum-dot based transistors, switches and gates, in order to optimize space usage or enhance performance of mobile devices. A processor may also be implemented as a combination of computing processing units.

In the subject specification, terms such as “store,” “data store,” data storage,” “database,” and substantially any other information storage component relevant to operation and functionality of a component and/or process, refer to “memory components,” or entities embodied in a “memory,” or components comprising the memory. It will be appreciated that the memory components described herein can be either volatile memory or nonvolatile memory, or can include both volatile and nonvolatile memory.

By way of illustration, and not limitation, nonvolatile memory, for example, can be included in database 410, non-volatile memory 1822 (see below), disk storage 1824 (see below), and memory storage 1846 (see below). Further, nonvolatile memory can be included in read only memory (ROM), programmable ROM (PROM), electrically programmable ROM (EPROM), electrically erasable ROM (EEPROM), or flash memory. Volatile memory can include random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Additionally, the disclosed memory components of systems or methods herein are intended to comprise, without being limited to comprising, these and any other suitable types of memory.

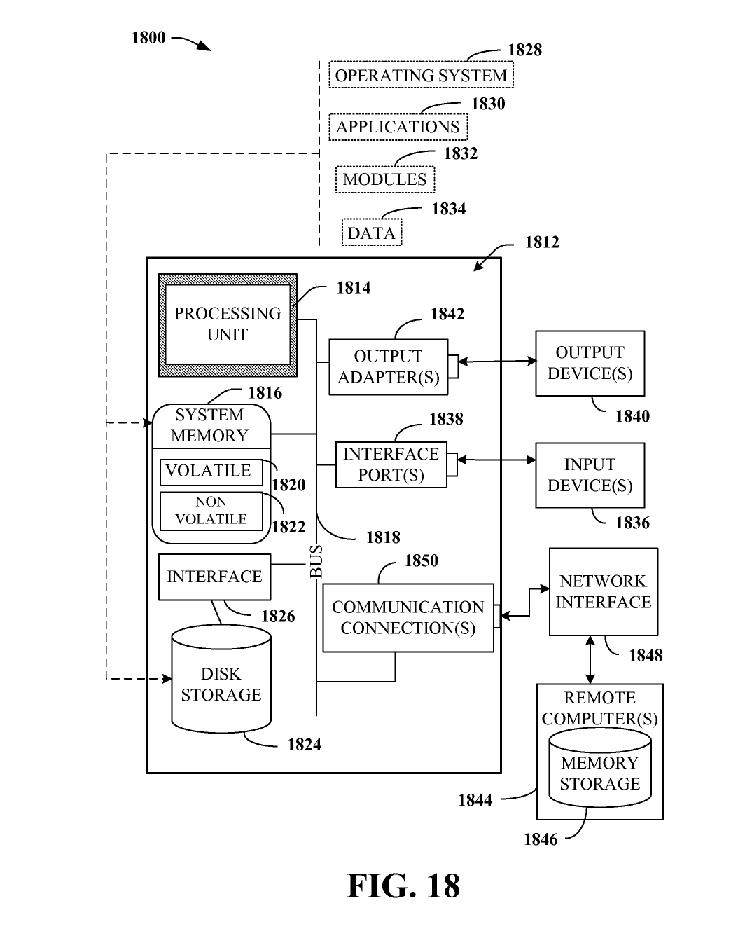

In order to provide a context for the various aspects of the disclosed subject matter, FIG. 18, and the following discussion, are intended to provide a brief, general description of a suitable environment in which the various aspects of the disclosed subject matter can be implemented. While the subject matter has been described above in the general context of computer-executable instructions of a computer program that runs on a computer and/or computers, those skilled in the art will recognize that the subject innovation also can be implemented in combination with other program modules. Generally, program modules include routines, programs, components, data structures, etc. that perform particular tasks and/or implement particular abstract data types.

Moreover, those skilled in the art will appreciate that the inventive systems can be practiced with other computer system configurations, including single-processor or multiprocessor computer systems, mini-computing devices, mainframe computers, as well as personal computers, hand-held computing devices (e.g., PDA, phone, watch), microprocessor-based or programmable consumer or industrial electronics, and the like. The illustrated aspects can also be practiced in distributed computing environments where tasks are performed by remote processing devices that are linked through a communications network; however, some if not all aspects of the subject disclosure can be practiced on stand-alone computers. In a distributed computing environment, program modules can be located in both local and remote memory storage devices.

With reference to FIG. 18, a block diagram of a computing system 1800 operable to execute the disclosed systems and methods is illustrated, in accordance with an embodiment. Computer 1812 includes a processing unit 1814, a system memory 1816, and a system bus 1818. System bus 1818 couples system components including, but not limited to, system memory 1816 to processing unit 1814. Processing unit 1814 can be any of various available processors. Dual microprocessors and other multiprocessor architectures also can be employed as processing unit 1814.

System bus 1818 can be any of several types of bus structure(s) including a memory bus or a memory controller, a peripheral bus or an external bus, and/or a local bus using any variety of available bus architectures including, but not limited to, Industrial Standard Architecture (ISA), Micro-Channel Architecture (MSA), Extended ISA (EISA), Intelligent Drive Electronics (IDE), VESA Local Bus (VLB), Peripheral Component Interconnect (PCI), Card Bus, Universal Serial Bus (USB), Advanced Graphics Port (AGP), Personal Computer Memory Card International Association bus (PCMCIA), Firewire (IEEE 1194), and Small Computer Systems Interface (SCSI).

System memory 1816 includes volatile memory 1820 and nonvolatile memory 1822. A basic input/output system (BIOS), containing routines to transfer information between elements within computer 1812, such as during start-up, can be stored in nonvolatile memory 1822. By way of illustration, and not limitation, nonvolatile memory 1822 can include ROM, PROM, EPROM, EEPROM, or flash memory. Volatile memory 1820 includes RAM, which acts as external cache memory. By way of illustration and not limitation, RAM is available in many forms such as SRAM, dynamic RAM (DRAM), synchronous DRAM (SDRAM), double data rate SDRAM (DDR SDRAM), enhanced SDRAM (ESDRAM), Synchlink DRAM (SLDRAM), Rambus direct RAM (RDRAM), direct Rambus dynamic RAM (DRDRAM), and Rambus dynamic RAM (RDRAM).

Computer 1812 also includes removable/non-removable, volatile/non-volatile computer storage media. FIG. 18 illustrates, for example, disk storage 1824. Disk storage 1824 includes, but is not limited to, devices like a magnetic disk drive, floppy disk drive, tape drive, Jaz drive, Zip drive, LS-100 drive, flash memory card, or memory stick. In addition, disk storage 1824 can include storage media separately or in combination with other storage media including, but not limited to, an optical disk drive such as a compact disk ROM device (CD-ROM), CD recordable drive (CD-R Drive), CD rewritable drive (CD-RW Drive) or a digital versatile disk ROM drive (DVD-ROM). To facilitate connection of the disk storage devices 1824 to system bus 1818, a removable or non-removable interface is typically used, such as interface 1826.

It is to be appreciated that FIG. 18 describes software that acts as an intermediary between users and computer resources described in suitable operating environment 1800. Such software includes an operating system 1828. Operating system 1828, which can be stored on disk storage 1824, acts to control and allocate resources of computer system 1812. System applications 1830 take advantage of the management of resources by operating system 1828 through program modules 1832 and program data 1834 stored either in system memory 1816 or on disk storage 1824. It is to be appreciated that the disclosed subject matter can be implemented with various operating systems or combinations of operating systems.

A user can enter commands or information, e.g., via interface component 1826, into computer 1811 through input device(s) 1836. Input devices 1136 include, but are not limited to, a pointing device such as a mouse, trackball, stylus, touch pad, keyboard, microphone, joystick, game pad, satellite dish, scanner, TV tuner card, digital camera, digital video camera, web camera, and the like. These and other input devices connect to processing unit 1814 through system bus 1818 via interface port(s) 1838. Interface port(s) 1838 include, for example, a serial port, a parallel port, a game port, and a universal serial bus (USB). Output device(s) 1840 use some of the same type of ports as input device(s) 1836.

Thus, for example, a USB port can be used to provide input to computer 1812 and to output information from computer 1812 to an output device 1840. Output adapter 1842 is provided to illustrate that there are some output devices 1840 like monitors, speakers, and printers, among other output devices 1840, which use special adapters. Output adapters 1842 include, by way of illustration and not limitation, video and sound cards that provide means of connection between output device 1840 and system bus 1818. It should be noted that other devices and/or systems of devices provide both input and output capabilities such as remote computer(s) 1844.

Computer 1812 can operate in a networked environment using logical connections to one or more remote computers, such as remote computer(s) 1844. Remote computer(s) 1844 can be a personal computer, a server, a router, a network PC, a workstation, a microprocessor based appliance, a peer device, or other common network node and the like, and typically includes many or all of the elements described relative to computer 1812.

For purposes of brevity, only a memory storage device 1846 is illustrated with remote computer(s) 1844. Remote computer(s) 1844 is logically connected to computer 1812 through a network interface 1848 and then physically connected via communication connection 1850. Network interface 1848 encompasses wire and/or wireless communication networks such as local-area networks (LAN) and wide-area networks (WAN). LAN technologies include Fiber Distributed Data Interface (FDDI), Copper Distributed Data Interface (CDDI), Ethernet, Token Ring and the like. WAN technologies include, but are not limited to, point-to-point links, circuit switching networks like Integrated Services Digital Networks (ISDN) and variations thereon, packet switching networks, and Digital Subscriber Lines (DSL).

Communication connection(s) 1850 refer(s) to hardware/software employed to connect network interface 1848 to bus 1818. While communication connection 1850 is shown for illustrative clarity inside computer 1812, it can also be external to computer 1812. The hardware/software for connection to network interface 1848 can include, for example, internal and external technologies such as modems, including regular telephone grade modems, cable modems and DSL modems, ISDN adapters, and Ethernet cards.

The above description of illustrated embodiments of the subject disclosure, including what is described in the Abstract, is not intended to be exhaustive or to limit the disclosed embodiments to the precise forms disclosed. While specific embodiments and examples are described herein for illustrative purposes, various modifications are possible that are considered within the scope of such embodiments and examples, as those skilled in the relevant art can recognize.

In this regard, while the disclosed subject matter has been described in connection with various embodiments and corresponding Figures, where applicable, it is to be understood that other similar embodiments can be used or modifications and additions can be made to the described embodiments for performing the same, similar, alternative, or substitute function of the disclosed subject matter without deviating therefrom. Therefore, the disclosed subject matter should not be limited to any single embodiment described herein, but rather should be construed in breadth and scope in accordance with the appended claims below.

What is claimed is:

1. A system, comprising:
an educational component configured to:
authorize, via a network computing environment, a first communication between the educational component and an educational terminal;
authorize, via the network computing environment, a second communication between the educational component and an instructor interface; and
transfer, via the network computing environment, educational path information between the educational terminal and the educational component in response to the second communication.

2. The system of claim 1, wherein the educational path information includes digitized textbook information.

3. The system of claim 1, wherein the educational path information relates to a lesson plan related to the educational terminal.

4. The system of claim 1, wherein the educational component is further configured to authorize the first communication in response to at least one of an alphanumeric registration, a voice activated registration, a biometric registration, or first information associated with the educational terminal.

5. The system of claim 1, wherein the educational component is further configured to authorize the second communication in response to predefined information being stored in a database of the educational component.

6. The system of claim 1, wherein the educational component is further configured to authorize, via the network computing environment, a third communication between the instructor interface and the educational terminal.

7. The system of claim 1, wherein the educational component is further configured to authorize, via the network computing environment, a third communication between a parental interface and at least one of the educational component, the instructor interface, or the educational terminal.

8. The system of claim 1, wherein the educational component is further configured to authorize, via the network computing environment, a third communication between the educational terminal and another educational terminal.

9. The system of claim 1, wherein the educational component is further configured to authorize, via the network computing environment, a third communication between an administrator component and at least one of the educational component, the instructor interface, or the educational terminal.

10. The system of claim 1, wherein the instructor interface is configured to:
track, via the network computing environment, tracking information associated with the educational path information.

11. The system of claim 9, wherein the tracking information includes at least one of a location of the educational terminal or information related to a lesson plan.

12. The system of claim 10, wherein the instructor interface is further configured to:
select the educational path information in response to the tracking information.

13. A portable communications device, comprising:
means for receiving information via at least one of a sound-based interface of the portable communications device or a touch-based interface of the portable communications device;
means for communicatively coupling, via a cloud computing environment, the portable communications device to an educational component in response to the means for receiving the information; and
means for displaying, by the portable communications device, educational path information in response to the means for communicatively coupling the portable communications device to the educational component.

14. The portable communications device of claim 13, further comprising:
means for communicatively coupling the portable communications device with an instructor interface in response to an output of the means for communicatively coupling the portable communications device to the educational component.

15. The portable communications device of claim 13, further comprising:
means for communicatively coupling the portable communications device with at least one an administrator component or a parental interface in response to an output of the means for communicatively coupling the portable communications device to the educational component.

16. The portable communications device of claim 13, further comprising:
means for communicatively coupling the portable communications device with another portable communications device in response to an output of the means for communicatively coupling the portable communications device to the educational component.

17. A method, comprising:
communicatively coupling, via a cloud computing environment, an educational component to an educational terminal and an instructor interface;
receiving, by the educational component, educational path information from the instructor interface in response to the communicatively coupling the educational component to the educational terminal; and
transferring information between the educational component and the educational terminal in response to the educational path information.

18. The method of claim 17, further comprising:
communicatively coupling, via the cloud computing environment, the educational terminal to a parental interface.

19. The method of claim 17, further comprising:
communicatively coupling, via the cloud computing environment, the educational terminal to at least one of an administrator component or the instructor interface.

20. The method of claim 17, further comprising:
communicatively coupling, via the cloud computing environment, the educational terminal to another educational terminal.
